(19) United States
(12) Patent Application Publication
(10) Pub. No.: US 2008/0142096 A1
(43) Pub. Date: Jun. 19, 2008

(54) Actuating Assembly

(76) Inventors: Markus Kliffken, Elchingen (DE); Christoph Kasper, Sonthofen (DE); Andreas Huber, Boehmenkirch (DE)

Correspondence Address: MICHAEL J. STRIKER, 103 EAST NECK ROAD, HUNTINGTON, NY, 11743, US

(21) Appl. No.: 11/913,566

(22) PCT Filed: May 11, 2006
(86) PCT No.: PCT/EP06/62247

§ 371 Date: Nov. 5, 2007

(30) Foreign Application Priority Data
May 19, 2005 (DE) 10 2005 023 113.6
Jun. 17, 2005 (DE) 10 2005 028 201.6

(51) Int. Cl. F16K 31/06

(52) U.S. Cl. 137/565.16

(57) ABSTRACT

The invention relates to an actuating assembly (1) for the electrohydraulic actuation of displaceable elements in a vehicle. Said actuating assembly (1) comprises a pump unit (4), an electric motor (3) that drives the pump unit (4), a hydraulic fluid tank (2) and at least one valve block (5) for controlling a volumetric flow that is generated by the pump unit (4). The pump unit (1) is equipped with a control unit (20) for electrically controlling the electric motor (3) and the valve block (5).

### RELATED ART

The present invention relates to an actuating assembly for the electrohydraulic actuation of displaceable elements in a motor vehicle.

Actuating assemblies are being used to an increasing extent in motor vehicles in order to increase the operating comfort experienced when actuating displaceable elements. Convertible tops, for example, and primarily the metal folding roofs in this case, are actuated using electrohydraulic actuating devices. It is known, e.g., to use radial piston pumps for this purpose, which generate the pressure required for a hydraulic actuating element. A radial piston pump of this type is known, e.g., from DE 100 28 368 A1. The volumetric flow generated by a pump of this type is distributed in accordance with the particular motion sequence, e.g., across a large number of valves to various actuating elements.

During the opening and closing process it must be possible to influence the entire quantity of fluid conveyed by the radial piston pump and to meter the volumetric flow to the individual actuating elements, e.g., the soft-top linkage, in an individualized manner. A control unit is required for this purpose, via which the volumetric flow to valves that control an actuating element may be controlled. A control unit of this type may also control, e.g., an electric drive motor of the hydraulic fluid pump, by way of which the overall volumetric flow is controllable.

The individual interacting elements of an actuating device of this type are typically located decentrally in a motor vehicle. It is common, for example, to locate a hydraulic fluid supply and the related piston pump in the region of the trunk, but to locate the electrical control components in the region of the central electrical and electronic system of the motor vehicle. As a result of a decentralized design of this type, however, production errors are likely, due to the considerable assembly effort required. The individual control devices—with their particular control signal receivers—may be wired incorrectly, or, given that components are scattered, it is also possible that the control results may deviate considerably and that conduction losses may occur, which may result, e.g., in inadequate pressure generation.

The object of the present invention, therefore, is to create an actuating assembly, with which the disadvantages of a decentralized location of the individual assemblies are prevented.

The object is attained with the inventive actuating assembly having the features of Claim 1.

The inventive actuating assembly for the electrohydraulic actuation of displaceable elements of a motor vehicle includes a pump unit and an electric motor that drives this pump unit. A hydraulic fluid tank and a valve block are also provided in the actuating assembly. The overall volumetric flow conveyed by the pump unit is controlled using the valve block and is thereby metered to the individual hydraulic actuating elements.

According to the present invention, an electronic control unit is integrated in the pump assembly, with which the electric motor and the valve block and/or its valves are controlled. All of the components required, e.g., to open or close a convertible top, are therefore combined in one single assembly. This has the advantage that long conduction paths between the control and the controlled elements are eliminated, and extensive preassembly is made possible. To operate the inventive pump assembly in a motor vehicle, only a small number of plug connectors need be provided between the wiring harness of the motor vehicle and the actuating assembly.

In addition, the entire actuating assembly may be inspected, e.g., in final quality control of the production process. In the inspection, individual elements are not inspected in terms of their isolated functions, but rather the entire assembly—including the interaction of the individual assemblies—may be tested in terms of its function. It may therefore also be ruled out, for example, that, given that components are scattered, a low control signal combined with a sluggish-running valve results in a volumetric flow that is too low for a hydraulic actuating element, which affects the correct function. In contrast to the decentralized design used previously, an error of this type becomes apparent in a final inspection of a module that is designed as an actuating assembly.

The wiring expenditure that is required is also reduced considerably. While individual control lines previously had to be guided from a control device to the individual valves, it is now sufficient to provide a central supply for the control unit of the actuating assembly. The individual control signals are then directed within the actuating assembly to the particular valves of the valve block and/or the electric motor. This eliminates a large portion of the wiring expenditure, by reducing the number of cables, and the path from the assigned control unit to a control signal receiver is shortened. Since the electrical lines that are installed currently make up a considerable portion of the weight of the motor vehicle—which is increasing anyway—the advantage also results that the weight of the motor vehicle is reduced by eliminating electrical lines.

The subclaims related to advantageous refinements of the inventive actuating assembly.

It is advantageous, in particular, to locate the electronic control unit directly on the valve block. A large portion of the inventive wiring is located between the electronic control unit and the valves that are located in a valve block. If, as is provided according to the present invention in a preferred embodiment, the electronic control unit is now located directly on the valve block, the shortest possible connection route results between the valves to be actuated and the control unit. According to the present invention, the valves of the valve block are electromagnetically actuatable. By locating the control unit directly on the valve block, it is even possible to provide a plug connection for a printed circuit board of the control unit with the valves to be controlled. It therefore becomes unnecessary to guide a cable between the control unit and the valves and/or their electromagnets. Via a plug connection of this type between the valves and/or their electromagnets and the control unit, assembly is also simplified further, since the connection between the electrical and mechanical components is accomplished simply via installation directly on a large number of electromagnets simultaneously.

It is also advantageous to provide a housing space in the valve block for accommodating the control unit. By providing a housing space of this type, it is possible to locate the control unit in a separate compartment, which may be sealed off. Since the valve block is a component that is manufactured anyway using a large number of complex—usually chip-removing—processing steps, it is easily possible to accommodate the control unit in the actuating assembly in a protected manner without the need for a separate housing.

According to a further subclaim, the valve block is composed of at least two valve sub-blocks. These two valve sub-blocks are located symmetrically to the pump unit. By dividing the valve block into at least two valve sub-blocks, it becomes possible to locate these two valve sub-blocks in a particularly space-saving manner due to their symmetrical placement. According to a further subclaim, it is particularly advantageous to assign a separate control block of the control unit to each of the valve sub-blocks. By dividing the control unit into one control block each for each valve sub-block, the advantage of the short connection paths between the valves of the valve sub-blocks and the particular control block is enhanced in particular.

According to a further subclaim, the pump unit is designed as a gear pump. An external-gear pump or an internal-gear pump may be used. The pump unit is located in a housing, on opposite sides of which a hydraulic fluid tank and an electric motor are located. In addition to the hydraulic fluid tank and the electric motor, a first valve sub-block and a second valve sub-block are also provided. This design makes it possible to accommodate all components required to operate the assembly in a small space, thereby making it possible to use a compact actuating assembly of this type even in difficult working situations.

It is advantageous, in particular, to provide two valve sub-blocks in the valve block, each valve sub-block including several valves. The individual valves of the valve sub-blocks are located essentially along a straight line. The two valve sub-blocks may be positioned such that the two straight lines on which the valves of the particular valve sub-block are located form an axial extension with each other. This one straight line is preferably located parallel to a longitudinal axis of the actuating assembly formed by the hydraulic fluid tank and the electric motor.

As an alternative, a plurality of valves is provided in each of the two valve sub-blocks, each of which is located on a separate straight line. The two valve sub-blocks are positioned, however, such that the two straight lines on which the valves of the particular valve sub-block are located are oriented parallel to each other. The two valve blocks are then both positioned such that the two parallel straight lines are positioned nearly perpendicularly on the longitudinal axis of the actuating assembly formed by the hydraulic fluid tank and the electric motor.

The two latter embodiments result in a particularly space-saving positioning of the hydraulic fluid tank, electric motor, and all of the valves, which are distributed between two valve sub-blocks. The special positioning of the valve sub-blocks also makes it possible to locate the plug connections to the particular control blocks in an easily accessible location.

Preferred embodiments of the inventive actuating assembly are presented in the drawing and are described in greater detail in the description below.

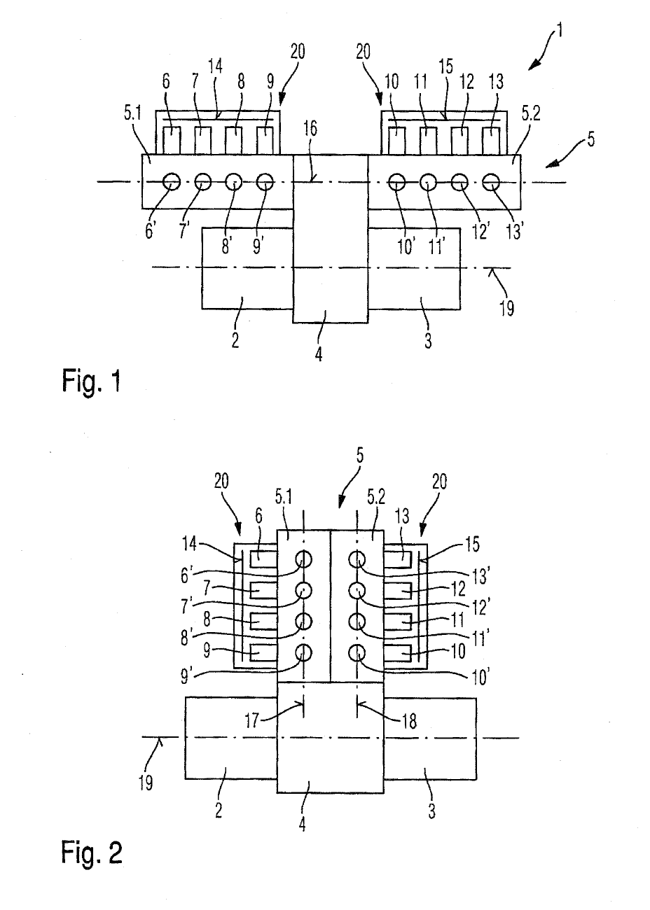

FIG. 1 shows a schematic depiction of a first exemplary embodiment of the inventive actuating device,

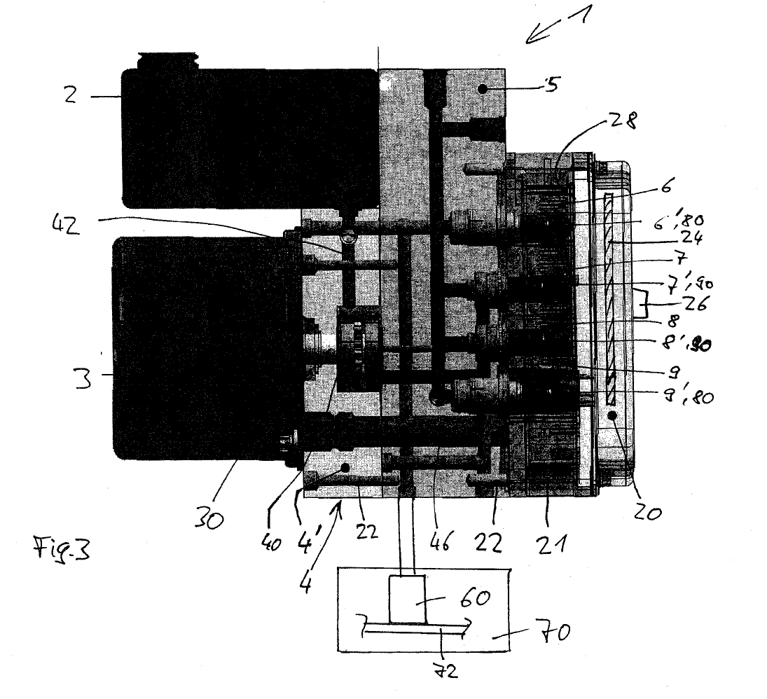

FIG. 2 shows a schematic depiction of a second exemplary embodiment of the inventive actuating device, and

FIG. 3 shows a third exemplary embodiment of the inventive actuating device.

Inventive actuating device 1 includes a hydraulic fluid tank 2, which contains the hydraulic fluid that is required to actuate the connected hydraulic actuating element, which is not shown in FIG. 1. The volumetric flow of hydraulic fluid required is generated by electromotor 3, which drives a pump unit 4. Pump unit 4 is preferably designed as a gear pump. The gear pump that is used may be an internal-gear pump or an external-gear pump. Pump unit 4 is located in a schematically depicted housing. This housing includes connections for accommodating hydraulic fluid tank 2 and electromotor 3, and connecting elements for connection with valve block 5.

In the exemplary embodiment shown, hydraulic fluid tank 2—out of which hydraulic fluid is pumped by pump unit 4—and electromotor 3 are located on opposite sides of pump unit 4. Hydraulic fluid tank 2 and electromotor 3 are preferably positioned such that they are located on one longitudinal axis 19 of actuating device 1.

Pump unit 4 and its housing extend laterally—relative to longitudinal axis 19—beyond hydraulic fluid tank 2 and electromotor 3, so that valve block 5 may be connected via a flange to pump unit 4 parallel to longitudinal axis 19 of actuating assembly 1. In the exemplary embodiment shown, a valve block 5 is provided, which is composed of a first valve sub-block 5.1 and a second valve sub-block 5.2. Each of the two valve sub-blocks 5.1 and 5.2 includes a plurality of electromagnetically actuated valves 6′ through 13′. Electromagnetically actuated valves 6′ through 13′ are preferably located along one straight line 16. As shown in FIG. 1, four electromagnets 6 through 9 and 10 through 13 for actuating electromagnetically actuatable valves 6′ through 13′ project out of valve sub-blocks 5.1 and 5.2. Each of the electromagnets 6 through 13 is assigned to a valve 6′ through 13′, which may be actuated by particular electromagnet 6 through 13, and which are depicted schematically in FIG. 1. Valve block 5 may also be designed as a single piece. Valves 6′ through 13′ are located in a single valve block 5, which, e.g., depending on the installation situation of actuating device 1, may also be located asymmetrically on one side of pump unit 4.

In FIG. 1, it is shown—for clarity—that electromagnets 6 through 13 clearly extend laterally out of the two valve sub-blocks 5.1 and 5.2. A first control block 14 and a second control block 15 are provided on the side of electromagnets 6 through 13 facing away from valve sub-blocks 5.1 and 5.2, first control block 14 and second control block 15 forming one electronic control unit 20 for actuating assembly 1. In the design shown, first control block 14—as a simple plug-in component—may be installed on electromagnets 6 through 9, and second control block 15—as a second plug-in component with a similar design—may be installed on electromagnets 10 through 13. Electromagnets 6 through 9 and 10 through 13 are therefore contacted directly via particular control blocks 14 and 15. The connection between the two control blocks 14 and 15 may be accomplished, e.g., using a set of connection lines, although this is not shown in FIG. 1. Nor is it shown in FIG. 1 that electric motor 3 is controlled via electronic control unit 20. The control for electromotor 3 is preferably located in only one of the two control blocks 14 or 15.

It is particularly preferred to form a housing compartment in each of the valve sub-blocks 5.1 and 5.2 for accommodating control blocks 14 and 15. Particular control block 14 or 15 is thereby protected by valve sub-block 5.1 or 5.2 against mechanical damage, and they are protected against influences such as moisture in the surroundings by a sealing cover that seals the housing compartment. In this manner, the risk of failure, e.g., due to contact corrosion, is prevented with minimal expenditure.

The embodiment shown in FIG. 1, with which all valves 6′ through 13′ and their electromagnets 6 through 13 are located along one straight line 16, and straight line 16 extends parallel with longitudinal axis 19 of actuating assembly 1, has the advantage that locating individual valves 6′ through 13′ next to each other results in a narrow design of actuating assembly 1, and it is possible to install the plug connections required to electrically supply control blocks 14 and 15 on just one side of actuating assembly 1. Further-extending electrical lines, which lead, e.g., to electromotor 3, are already installed inside actuating assembly 1, thereby making it possible to install entire actuating assembly 1 in the motor vehicle such that only the side facing away from hydraulic fluid tank 2 and electromotor 3 remain accessible.

An alternative embodiment is shown in FIG. 2. Instead of positioning single straight line 16 parallel to longitudinal axis 19 of actuating assembly 1, it is provided in the second exemplary embodiment of FIG. 2 that valve block 5 now includes a first valve sub-block 5.1 and a second valve sub-block 5.2, but that the two valve sub-blocks 5.1 and 5.2 are not positioned in axial succession, but rather parallel to each other.

In the exemplary embodiment shown, each of the two valve sub-blocks 5.1 and 5.2 includes four valves 6′ through 9′ and 10′ through 13′, each of which is controlled by an electromagnet 6 through 9 and 10 through 13. Valves 6′ through 9′ are located on a first straight line 17. First straight line 17 is located essentially perpendicular to longitudinal axis 19 of actuating assembly 1. Accordingly, the four valves 10′ through 13′ in second valve sub-block 5.2 are also located on a second straight line 18, which extends perpendicularly to longitudinal axis 19 of actuating assembly 1. The two straight lines 17 and 18 are oriented parallel to each other and are therefore both located perpendicular to longitudinal axis 19. Electromagnets 6 through 13—which project laterally out of valve sub-blocks 5.1 and 5.2—are located on opposite sides of valve sub-blocks 5.1 and 5.2. Electromagnets 6 through 9 and 10 through 13 therefore extend in the direction of hydraulic fluid tank 2 and in the direction of electromotor 3. Due to the positioning of electromagnets 6 through 9 opposite to electromagnets 10 through 13, first control block 14 and second control block 15 are located on opposite sides of actuating assembly 1.

Two preferred exemplary embodiments of inventive actuating assembly 1 are depicted in FIGS. 1 and 2. The location of control unit 20 in actuating assembly 1 is not bound to the locations of the two control blocks 14 and 15—which form control unit 20—shown, however. Rather, other locations of control unit 20 inside actuating assembly 1 are feasible, depending on the particular installation situation. An actuating assembly 1 that is integrated in this manner and is used for electrohydraulic actuation may be used for more than just actuating a convertible top, which is the basis of the present exemplary embodiment. Rather, any type of actuation of displaceable elements provided on a motor vehicle is possible. Examples includes extendable spoilers, extendable loading platforms, and automatically actuatable trunk flaps.

FIG. 3 shows a further actuating device 1, in the case of which control unit 20 is installed on valve block 5. Valves 6′ through 9′ extend out of valve block 5 into a housing 21 in which electromagnets 6 through 9 are located, electromagnets 6 through 9 being designed as toroidal coils. Electromagnets 6′ through 9′ are mounted, e.g., on a punched grid 28, which is supported in housing 21 and is electrically connected with control unit 20. Housing 21 is flange-connected to valve block 5 via connecting means 22. Control unit 20—in which a printed circuit board 24 is located, for example, and which includes a plug connection 26—is located opposite to valve block 5 on housing 21. In addition, valve block 5 is connected with pump unit 4, which includes a pump housing 4′, which is flange-connected with valve block 5. A gear pump 40, for example, is located in pump housing 4′, gear pump 40 being driven by an armature shaft 30 of electromotor 3. To this end, pump housing 4′ is fixedly connected with electromotor 3. In the exemplary embodiment, electromotor 3, pump housing 4′, valve block 5, coil housing 21, and control unit 20 are all flange-connected with each other axially relative to armature shaft 30, in order to form the most compact actuating assembly 1 possible. To electrically connect electromotor 3 with control unit 20, a feed-through 46 is formed in housing 4′ of pump unit 4 and the at least one valve block 5. As a result, with axial assembly along longitudinal axis 19, an electrical connection may be established through feed-through 46. Hydraulic fluid tank 2 is also fixedly connected with pump housing 4′, and a hydraulic line 42 directs the hydraulic fluid from hydraulic fluid tank 2 to pump unit 4. Hydraulic fluid tank 2 is simultaneously braced against valve block 5. In a not-shown variation, hydraulic fluid tank 2 may also be installed on the same side as pump housing 4′ as electromotor 3. Valve block 5 includes a large number of bores 50, which serve as hydraulic lines and connect valves 6′ through 9′ with related actuating devices 60, e.g., of a convertible top 70. For example, valves 6′ and 9′ are designed as regulatable proportioning valve 80, and valves 7′ and 8′ are designed as digital switching valves 90. Hydraulic actuating elements 60 are designed, e.g., as hydraulic cylinders 60, which are connected with a soft-top linkage 72 of convertible top 70.

The present invention is not limited to the exemplary embodiments shown. In particular, any combination of individual features of the exemplary embodiments is possible.

What is claimed is:

1. An actuating assembly (1) for the electrohydraulic actuation of displaceable elements in a motor vehicle, including a pump unit (4), an electric motor (3) that drives the pump unit (4), a hydraulic fluid tank (2), and at least one valve block (5) for controlling a volumetric flow generated by the pump unit (4),
wherein
a control unit (20) for electrically controlling the electric motor (3) and the valve block (5) is provided in the actuating assembly (1), and the valve block (5) includes one or more electromagnetically actuatable valves (6 through 13).

2. The actuating assembly as recited in claim 1,
wherein
the control unit (20) is located on the valve block (5) and, in particular, a housing space for accommodating the control unit (20) is formed in the valve block (5).

3. The actuating assembly as recited in claim 1,
wherein
the pump unit (4) is formed as a single component with the valve block (5) and, in particular, the pump unit (4) is integrated in the valve block (5).

4. The actuating assembly as recited in claim 1,
wherein
the valve block (5) includes two valve sub-blocks (5.1, 5.2), which are located symmetrically to the pump unit (4).

5. The actuating assembly as recited in claim 1,
wherein
a control block (14, 15) of the control unit (20) is located on each of the valve sub-blocks (5.1, 5.2).

6. The actuating assembly as recited in claim 1,
wherein
the pump unit (4) is designed as gear pump (40), in particular as an internal-gear pump or an external-gear pump.

7. The actuating assembly as recited in claim 1,
wherein
the pump unit (4) is a piston pump (axial/radial) or a vane pump (10).

8. The actuating assembly as recited in claim 1,
wherein
the pump unit (4) is a variable-displacement pump or a fixed-delivery pump.

9. The actuating assembly as recited in claim 1,
wherein
the pump unit (4) is located in a housing (4′), on which the hydraulic fluid tank (2) and the electric motor (3) are directly located, being connected thereto via a flange, in particular.

10. The actuating assembly as recited in claim 1,
wherein
the hydraulic fluid tank (2) is located opposite to the electric motor (3)—in particular on a common longitudinal axis (19)—on the housing (4′) of the pump unit (4).

11. The actuating assembly as recited in claim 1,
wherein
a first valve block (5.1) and, in particular, a second valve block (5.2), are located on the housing (4′) of the pump unit (4).

12. The actuating assembly as recited in claim 1,
wherein
a plurality of valves (6′ through 9′; 10′ through 13′) is located in the first and second valve sub-blocks (5.1, 5.2), essentially along a straight line (17, 18) in each case, these straight lines (17, 18) being oriented parallel to each other and perpendicular to a longitudinal axis (19) of the actuating assembly (1) formed by the hydraulic fluid tank (2) and the electric motor (3).

13. The actuating assembly as recited in claim 1,
wherein
a plurality of valves (6′ through 13′) is located in the first and second valve sub-blocks (5.1, 5.2), the valves (6′ through 13′) of both valve sub-blocks (5.1, 5.2) being located essentially along one straight line (16), this one straight line (16) being oriented parallel to a longitudinal axis (19) of the actuating assembly (1) formed by the hydraulic fluid tank (2) and the electric motor (3).

14. The actuating assembly as recited in claim 1,
wherein
the at least one valve block (5) includes proportionally switched valves (80) and digitally switched valves (90).

15. The actuating assembly as recited in claim 1,
wherein
the control unit includes a printed circuit board (24), which is insertable via plug connections onto the valves (6′ through 9′) of the valve block (5) that are to be controlled, in particular on their electromagnets (6 through 9).

16. The actuating assembly as recited in claim 1,
wherein
the electric motor (3), the pump unit (4, 4′), the at least one valve block (5), and the control unit are all located axially adjacent to each along the longitudinal axis (19), being connected to each other via a flange, in particular.

17. The actuating assembly as recited in claim 1,
wherein
the hydraulic fluid tank (2) bears via one side against the housing (4′) of the pump unit (4), and via another side against the at least one valve block (5).

18. The actuating assembly as recited in claim 1,
wherein
an electrical feed-through (46) is located coaxially in the housing (4′) of the pump unit (4) and in the at least one valve block (5), through which the control unit (20) is electrically connected with the electric motor (3).

19. A convertible top (70) with an electrohydraulic actuating assembly (1) as recited in claim 1,
wherein
the actuating assembly (1) is connected with hydraulic actuating elements (60) of a soft-top linkage (72).
